(19) United States
(12) Patent Application Publication
(10) Pub. No.: US 2011/0195311 A1
(43) Pub. Date: Aug. 11, 2011

(54) NEGATIVE ELECTRODE FOR RECHARGEABLE LITHIUM BATTERY, METHOD FOR MANUFACTURING THEREOF, AND RECHARGEABLE LITHIUM BATTERY COMPRISING THE SAME

(76) Inventors: Beom-Kwon Kim, Yongin-si (KR); Tae-Sik Kim, Yongin-si (KR); Kyu-Nam Joo, Yongin-si (KR); Jae-Myung Kim, Yongin-si (KR)

(21) Appl. No.: 12/845,520

(22) Filed: Jul. 28, 2010

(30) Foreign Application Priority Data
Feb. 8, 2010 (KR) 10-2010-0011497

(51) Int. Cl. H01M 4/38; B05D 5/12

(52) U.S. Cl. 429/231.8; 427/77; 427/78; 977/742; 977/762

(57) ABSTRACT

A negative electrode for a rechargeable lithium battery includes at least one layered unit including a Sn-based metal plating layer and a carbon layer on the metal plating layer. Rechargeable lithium batteries including the negative electrode exhibit improved charge and discharge capacities, and have good capacity retention characteristics even after repeated charge and discharge.

### CROSS-REFERENCE TO RELATED APPLICATION

This application claims priority to and the benefit of Korean Patent Application No. 10-2010-0011497 filed in the Korean Intellectual Property Office on Feb. 8, 2010, the entire contents of which are incorporated herein by reference.

### BACKGROUND OF THE INVENTION

1. Field of the Invention

This disclosure relates to negative electrodes for rechargeable lithium batteries, methods of manufacturing the same, and rechargeable lithium batteries including the same.

2. Description of the Related Art

Lithium metal has been conventionally used as a negative active material. However, since lithium metal causes battery short-circuits due to dendrites, which may lead to explosion, there has been a recent tendency to replace the lithium metal with a carbon-based material as the negative active material.

Carbon-based active materials used as the negative active material for a lithium battery may include crystalline carbon (such as graphite and artificial graphite), and amorphous carbon (such as soft carbon and hard carbon). However, while amorphous carbon has large capacity, it is largely irreversible during charge and discharge. Crystalline carbon representatively includes graphite. Since graphite has a high theoretical capacity limit of 372 mA h/g, it is presently used as a negative active material. However, although graphite or carbon-based active materials have high theoretical capacities of around 380 mAh/g, they may not be used as the aforementioned negative electrode for future high-capacity lithium batteries.

Research is being actively undertaken into metal-based or intermetallic compound-based negative active materials. For example, lithium batteries including metals such as aluminum, germanium, silicon, tin, zinc, lead, and the like, or semimetals as the negative active material are being researched. However, conventional negative active materials cannot acquire satisfactory charge and discharge performance, thus leaving much room for improvement.

### SUMMARY OF THE INVENTION

According to exemplary embodiments of the present invention, a negative electrode for a battery has a good capacity retention rate despite increasing cycle numbers.

According to embodiments of the present invention, a negative electrode for a rechargeable lithium battery includes at least one layered unit including a metal plating layer including Sn and a carbon layer including a carbon material on the metal plating layer.

According to other embodiments of the present invention, the metal plating layer may be about 1 to about 5 μm thick.

According to yet other embodiments, the metal plating layer may have a surface roughness ranging from about 1000 to about 10,000 Å.

According to still other embodiments of the present invention, the carbon material may be selected from carbon nanotubes, amorphous carbon, carbon nanowires, carbon nanorods, and combinations thereof.

According to embodiments of the present invention, the layered unit may include from 1 to 3 laminated units.

According to other embodiments of the present invention, a method of manufacturing a negative electrode for a rechargeable lithium battery includes: a) preparing a current collector; b) disposing a metal plating layer including Sn on the current collector; and c) disposing a carbon layer including a carbon material on the metal plating layer.

According to embodiments of the present invention, the process of disposing a Sn-based metal plating layer on the carbon material layer (as in c) and of disposing a carbon material layer on the metal plating layer (as in b) may be repeated at least once.

According to some embodiments of the present invention, the metal plating layer may be about 1 to about 5 μm thick.

According to other embodiments of the present invention, the metal plating layer may have a surface roughness ranging from about 1000 to about 10,000 Å.

According to embodiments of the present invention, the carbon material may be selected from carbon nanotubes, amorphous carbon, carbon nanowires, carbon nanorods, and combinations thereof.

According to another embodiment of the present invention, the process of disposing a Sn-based metal plating layer on the carbon material layer (as in c) and of disposing a carbon material layer on the metal plating layer (as in b) may be repeated from 1 to 3 times.

According to other embodiments of the present invention, the method may further include heat-treatment after disposing the carbon layer. The heat-treatment may be performed at a temperature ranging from about 200 to about 250° C. for about 2 to about 6 hours.

According to embodiments of the present invention, the carbon layer may be disposed by preparing a suspension by dispersing a carbon material in a solvent and then spraying the suspension on the metal plating layer.

According to embodiments of the present invention, the solvent may be selected from ethanol, isopropyl alcohol, methanol, and combinations thereof.

According to other embodiments of the present invention, a rechargeable lithium battery includes a positive electrode, a negative electrode, a separator between the positive and negative electrodes and an electrolyte impregnating the positive and negative electrodes and separator. The positive electrode includes a positive active material, a conductive material, and a binder. The negative electrode includes at least one layered unit including a Sn-based metal plating layer and a carbon material layer on the metal plating layer.

The lithium batteries according to the present invention have improved capacity retention characteristics and thus improved reliability even when repeatedly charged and discharged. The batteries also have high charge and discharge capacities.

### BRIEF DESCRIPTION OF THE DRAWINGS

FIG. 1A is a cross-sectional view of a layered unit having a metal plating layer having low surface roughness.

FIG. 1B is a cross-sectional view of a layered unit having a metal plating layer having a higher surface roughness.

FIG. 2A is a schematic cross-sectional view of a method of fabricating a negative electrode according to an embodiment of the present invention.

FIG. 2B is a schematic cross-sectional view of a method of fabricating a negative electrode according to another embodiment of the present invention.

FIG. 3A is cross-sectional SEM photograph of the negative electrode prepared according to Example 1.

FIG. 3B is a cross-sectional SEM photograph of a negative electrode prepared according to Comparative Example 1.

FIG. 4A is a cross-sectional SEM photograph of a negative electrode prepared according to Example 2.

FIG. 4B is a cross-sectional SEM photograph of a negative electrode prepared according to Comparative Example 2.

FIG. 5 is a graph comparing the capacity retention of Examples 3 and 4 and Comparative Examples 3 and 4.

FIG. 6 is a cross-sectional perspective view of a lithium battery according to an embodiment of the present invention.

### DETAILED DESCRIPTION OF THE EMBODIMENTS

Exemplary embodiments of the present invention will hereinafter be described in detail. However, these embodiments are only exemplary, and the present invention is not limited thereto.

Rechargeable lithium batteries can be classified into lithium ion batteries, lithium ion polymer batteries, and lithium polymer batteries depending on the kind of separator and electrolyte used. The batteries may have a shape such as a cylinder, a prism, a coin, a pouch, or the like. The batteries can be bulk type, thin film type, or the like depending on the size.

In general, a rechargeable lithium battery is fabricated by sequentially stacking a negative electrode, a positive electrode, and a separator, spiral-winding them and housing the wound product in a container.

The negative electrode includes a current collector and a negative active material layer disposed on the current collector. The negative active material layer includes a negative active material.

The negative active material may include a material that can reversibly intercalate/deintercalate lithium ions, lithium metal, a lithium metal alloy, a material doped and dedoped with lithium, or a transition metal oxide.

Carbon materials that can reversibly intercalate/deintercalate lithium ions may include any carbon-based negative active material generally used in lithium ion secondary batteries, for example, crystalline carbon, amorphous carbon, or a combination thereof. The crystalline carbon may include shapeless graphite, sheet-type graphite, flake-type graphite, spherical-shaped graphite, fiber-shaped natural graphite, artificial graphite, or a mixture thereof. The amorphous carbon may include soft carbon (carbon fired at a low temperature) or hard carbon, mesophase pitch carbide, fired cokes, or a mixture thereof.

The lithium metal alloy may include a lithium alloy including a metal selected from Na, K, Rb, Cs, Fr, Be, Mg, Ca, Sr, Si, Sb, Pb, In, Zn, Ba, Ra, Ge, Al, and Sn.

The material doped and dedoped with lithium may include Si, SiOₓ (0<x<2), Si-Q alloys (in which Q is an element selected from alkali metals, alkaline-earth metals, Group 13 elements, Group 14 elements, transition elements, rare earth elements, and combinations thereof, but is not Si), Sn, SnO₂, Sn—R (in which R is an element selected from alkali metals, alkaline-earth metals, Group 13 elements, Group 14 elements, transition elements, rare earth elements, and combinations thereof, but is not Sn), and the like, or a mixture of at least one thereof with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and combinations thereof. In addition, in some embodiments, at least one thereof may be mixed with SiO₂.

The transition metal oxide may include vanadium oxide, lithium vanadium oxide, and the like.

In addition, the crystalline carbon may be prepared from a mesophase spherical shaped particle to a carbon material by carbonization and graphitization, or from mesophase pitch fiber to graphite fiber by carbonization and graphitization.

The negative active material layer may also include a binder, and optionally a conductive material.

The binder serves to bind negative active material particles together and also to attach the negative active material to a current collector. The binder may include a non-water-soluble binder, a water-soluble binder, or a combination thereof.

Nonlimiting examples of suitable non-water-soluble binders include polyvinylchloride, carboxylated polyvinylchloride, polyvinylfluoride, polymers including ethylene oxide, polyvinylpyrrolidone, polyurethane, polytetrafluoroethylene, polyvinylidene fluoride, polyethylene, polypropylene, polyamideimide, polyimide, and combinations thereof.

Nonlimiting examples of the water-soluble binder include styrene-butadiene rubber, acrylated styrene-butadiene rubber, polyvinyl alcohol, polyacrylic acid sodium, copolymers of propylene with an olefin having 2 to 8 carbons, copolymers of (meth)acrylic acid with (metha)acrylic acid alkylester, and combinations thereof.

When a water-soluble binder is used as the negative electrode binder, it may further include a cellulose-based compound for increasing viscosity. The cellulose-based compound may include at least one of carboxymethyl cellulose, hydroxypropylmethyl cellulose, methyl cellulose, and an alkali metal salt thereof. The alkali metal may include Na, K, or Li. This thickener may be included in an amount of about 0.1 to about 3 parts by weight based on 100 parts by weight of the binder.

The conductive material is used to impart conductivity to the electrode and may include any electronically conductive material that does not cause a chemical change. Nonlimiting examples of suitable conductive materials include carbon-based materials such as natural graphite, artificial graphite, carbon black, acetylene black, ketjen black, carbon fibers, and the like; metal-based materials such as metal powders such as copper, nickel, aluminum, silver, and the like, or metal fibers and the like; conductive polymers such as polyphenylene derivatives and the like; and mixtures thereof.

The current collector may be selected from copper films, nickel films, stainless steel films, titanium films, nickel foams, copper foams, polymer substrates coated with a conductive metal, and combinations thereof.

According to embodiments of the present invention, a negative electrode may be prepared by depositing at least one layered unit including a Sn-based metal plating layer on the current collector and a carbon material layer on the metal plating layer.

The metal plating layer may be about 1 to about 5 μm or about 1 to about 2 μm thick. When the conductive carbon material layer is disposed on a comparatively thin plating layer, it can reduce or prevent sharp deteriorations in initial capacity retention rates due to volume expansion of a Sn-based negative electrode material. The reason for this is that lithium ions are inserted into the carbon layer as well as the Sn-based metal layer, and can compensate for the non-reversible capacity loss of the Sn-based metal, and thus make up for the deterioration in the capacity retention rate due to initial efficiency increases and volume expansion.

In addition, even though the Sn-based metal is deintercalated from the current collector due to the carbon material temporarily moving according to volume expansion, the carbon material capable of forming a network structure (e.g., carbon nanotubes) can serve as a conductive layer, improving the cycle characteristic of the battery.

The metal plating layer has a surface roughness ranging from about 1000 Å to about 10,000 Å. When the metal plating layer has a surface roughness within this range, the carbon material can serve as a medium for alleviating volume change and also as a conductive layer.

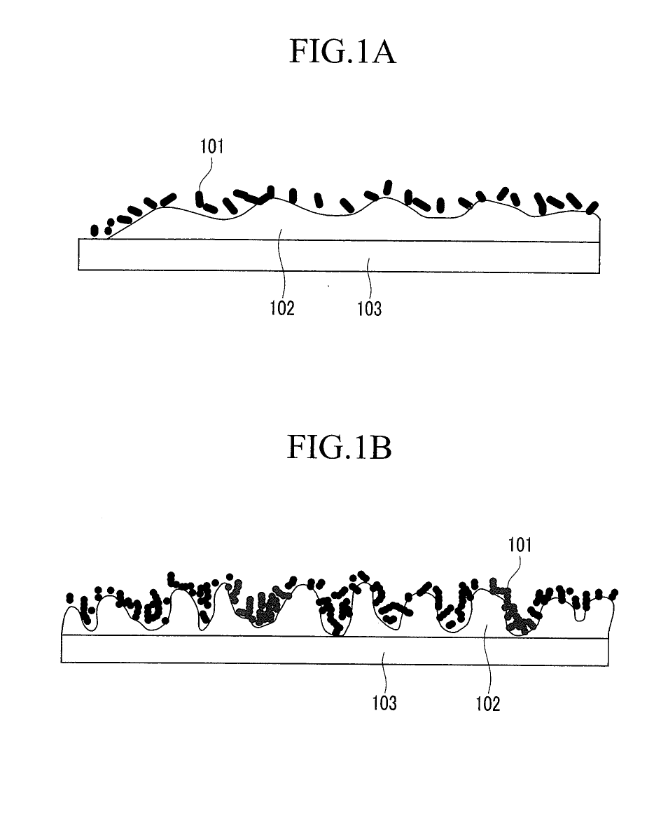

FIGS. 1A and 1B show the distribution of a carbon material 101 according to the surface roughness of the metal plating layer 102 on a current collector 103. As shown in FIG. 1A, when the metal plating layer 102 has low surface roughness, the carbon material 101 may not sufficiently act as the above-described medium. On the contrary, FIG. 1B shows that when a metal plating layer 102 has high surface roughness, the carbon material 101 can densely fill the surface of the metal plating layer 102, accomplishing the effects of the present invention.

The carbon material may be selected from carbon nanotubes, amorphous carbon, carbon nanowires, carbon nanorods, and combinations thereof. The materials are conductive and can form a compound with lithium. In particular, since carbon nanotubes and carbon nanowires have high strength and a three-dimensional network structure when they agglomerate, they can move into a matrix to alleviate volume changes in the active material.

In addition, one to three of the layered units may be laminated on the negative electrode. When the number of layered units laminated on the negative electrode is within this range, the carbon layer may alleviate volume changes in the active material with fewer laminating processes. When the number of layered units laminated on the negative electrode is outside of this range, the number of laminating processes increases, thereby increasing cost.

According to other embodiments of the present invention, a method of manufacturing a negative electrode includes: a) preparing a current collector, b) disposing a Sn-based metal plating layer on the current collector, and c) disposing a carbon material layer on the metal plating layer.

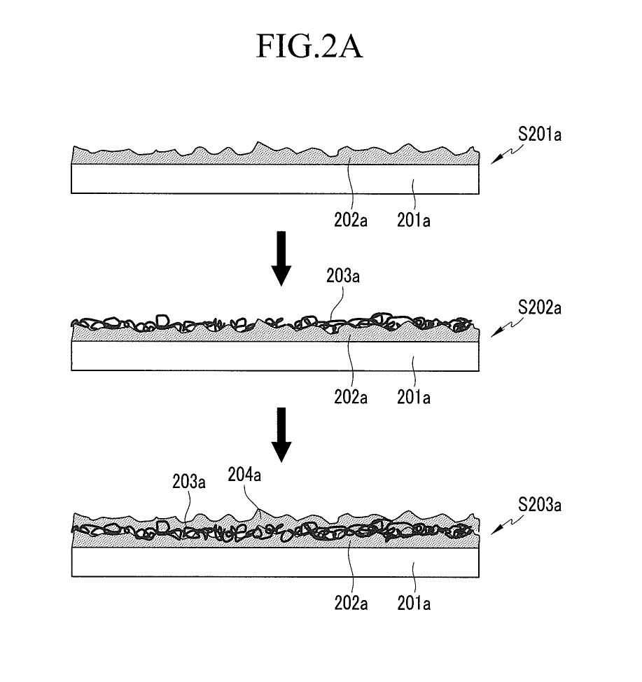

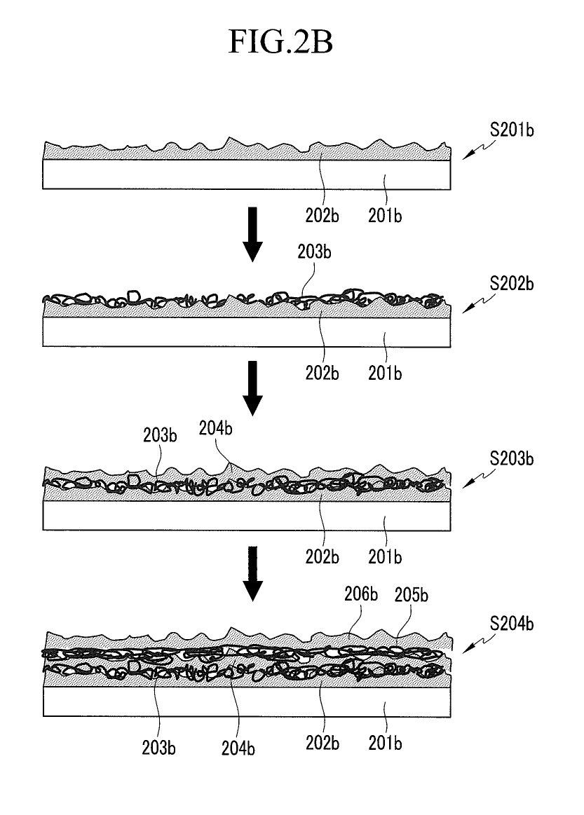

Hereinafter, the manufacturing method is described with reference to FIGS. 2A and 2B.

Current collectors 201a and 201b may include the same material as described above.

The deposition S201a and S201b of the Sn-based metal plating layers 202a and 202b on the current collector are performed at high current density over a short time period in order to form metal plating layers 202a and 202b that are thin and have high surface roughness.

The current density for the plating may be about 5 A/dm² to about 15 A/dm². The metal plating layers 202a and 202b may have surface roughnesses ranging from about 1000 Å to about 10,000 Å.

In addition, the metal plating layers 202a and 202b may be about 1 to about 5 μm, or about 1 to about 2 μm thick. When the conductive carbon material layers 203a and 203b are disposed on relatively thin metal plating layers (S202a and S202b), they can reduce or prevent sharp deteriorations in the initial capacity retention rate due to volume expansion of the Sn-based negative electrode material.

In addition, deposition S204b of a Sn-based metal plating layer 204b on the carbon layer 203b (formed according to c) and deposition of a carbon material layer 205b on the metal plating layer 204b may be repeated more than once. As these depositions are repeated, metal plating layers 202b and 204b and carbon layers 203b and 205b are laminated on the current collector 201b. When the deposition S204b is repeated 1 to 3 times, the above described effects can be easily accomplished.

The carbon material may be selected from carbon nanotubes, amorphous carbon, carbon nanowires, carbon nanorods, and combinations thereof. The materials are conductive and can form a compound with lithium. In particular, since carbon nanotubes and carbon nanowires have high strength and a three-dimensional network when agglomerated, they can move into a matrix to alleviate volume changes in the active material.

The deposition S202a and S202b of carbon layers 203a and 203b is performed by preparing a suspension including dispersing a carbon material into a solvent and spraying the suspension on the metal plating layers 202a and 202b.

When the carbon layers 203a and 203b are sprayed, the carbon layers 203a and 203b may be thin. In addition, the carbon layers 203a and 203b may include a carbon material having uniform density.

The solvent may be selected from ethanol, isopropyl alcohol, methanol, and combinations thereof, but may include any solvent capable of being absorbed in a carbon material without deteriorating the dispersion characteristic.

After depositing the carbon layers 203a and 203b, the negative electrode may be further heat-treated at a temperature ranging from about 200 to about 250° C. for about 2 to about 6 hours.

The heat treatment may be performed to prevent the carbon layers 203a and 203b on the surface from delaminating from the Sn-based metal plating layers 202a and 202b. It may be performed at a temperature ranging from about 200 to about 250° C. for about 2 to about 6 hours.

After repeating the deposition process n times, the carbon layers 203a and 205b can be disposed on the surface of the negative electrode, and then Sn-based metal layers 204a and 206b can be plated on the carbon layers 203a and 205b. Deposition of the final metal plating layers 204a and 206b is the same as described above. The negative electrode may then be heat-treated again at a temperature ranging from about 200 to about 250° C. for about 2 to about 12 hours to prevent delamination.

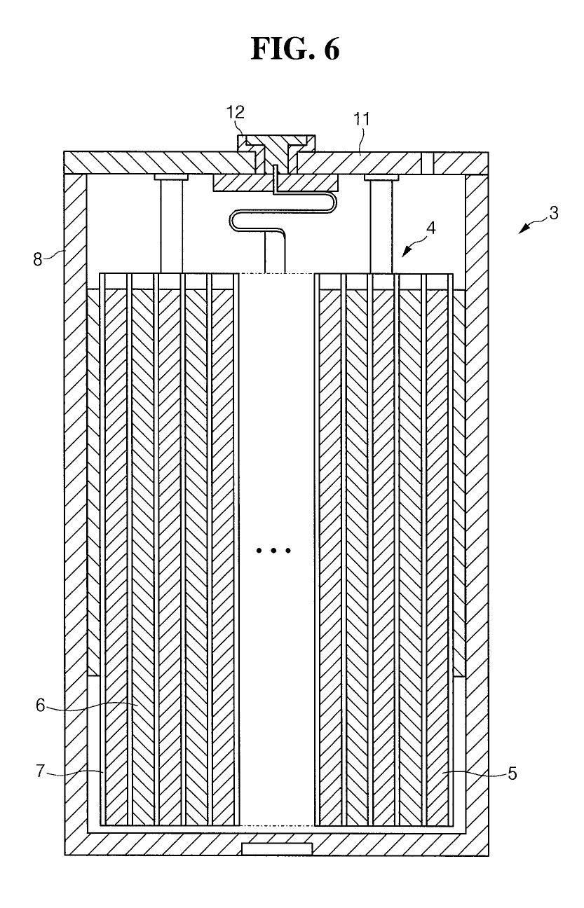

According to other embodiments of the present invention, a rechargeable lithium battery includes the above described negative electrode. As shown in FIG. 6, the lithium battery 3 includes an electrode assembly 4 including a positive electrode 5, negative electrode 6 and a separator 7 between the positive electrode 5 and negative electrode 6. The electrode assembly 4 is housed in a battery case 8, and sealed with a cap plate 11 and sealing gasket 12. An electrolyte is injected into the battery case to complete the battery. The positive electrode includes a positive active material, a conductive material, and a binder. The negative electrode includes at least one layered unit including a Sn-based metal plating layer and a carbon layer on the metal plating layer.

The negative electrode for the rechargeable lithium battery including at least one layered unit including a Sn-based metal plating layer and a carbon layer disposed on the metal plating layer is as described above.

The positive electrode includes a current collector and a positive active material layer disposed on the current collector. The positive active material includes lithiated intercalation compounds that reversibly intercalate and deintercalate lithium ions. The positive active material may include a composite oxide selected from cobalt, manganese, and nickel, as well as lithium, and combinations thereof. In particular, the following lithium-containing compounds of Formulas 1-27 may be used:

LiₐA_{1-b}X_{b}D₂ (0.90≦a≦1.8, 0≦b≦0.5) (1)

LiₐA_{1-b}X_{b}O_{2-c}D_{c}(0.90≦a≦1.8, 0≦b≦0.5, 0≦c≦0.05) (2)

LiE_{1-b}X_{b}O_{2-c}D_{c} (0≦b≦0.5, 0≦c≦0.05) (3)

LiE_{2-b}X_{b}O_{4-c}D_{c} (0≦b≦0.5, 0≦c≦0.05) (4)

LiₐNi_{1-b-c}CO_{b}X_{c}D_{α} (0.90≦a≦1.8, 0≦b≦0.5, 0≦c≦0.05, 0≦α≦2) (5)

LiₐNi_{1-b-c}CO_{b}X_{c}O_{2-α}T_{α} (0.90≦a≦1.8, 0≦b≦0.5, 0≦c≦0.05, 0≦α≦2) (6)

LiₐNi_{1-b-c}CO_{b}X_{c}O_{2-α}T₂ (0.90≦a≦1.8, 0≦b≦0.5, 0≦c≦0.05, 0≦α≦2) (7)

LiₐNi_{1-b-c}Mn_{b}X_{c}D_{α} (0.90≦a≦1.8, 0≦b≦0.5, 0≦c≦0.05, 0≦α≦2) (8)

LiₐNi_{1-b-c}Mn_{b}X_{c}O_{2-α}T_{α} (0.90≦a≦1.8, 0≦b≦0.5, 0≦c≦0.05, 0≦α≦2) (9)

LiₐNi_{1-b-c}Mn_{b}X_{c}O_{2-α}T₂ (0.90≦a≦1.8, 0≦b≦0.5, 0≦c≦0.05, 0≦α≦2) (10)

LiₐNi_{b}E_{c}G_{d}O₂ (0.90≦a≦1.8, 0≦b≦0.9, 0≦c≦0.5, 0.001≦d≦0.1) (11)

LiₐNi_{b}CO_{c}Mn_{d}GₑO₂ (0.90≦a≦1.8, 0≦b≦0.9, 0≦c≦0.5, 0≦d≦0.5, 0.001≦e≦0.1) (12)

LiₐNiG_{b}O₂ (0.90≦a≦1.8, 0.001≦b≦0.1) (13)

LiₐCoG_{b}O₂ (0.90≦a≦1.8, 0.001≦b≦0.1) (14)

LiₐMnG_{b}O₂ (0.90≦a≦1.8, 0.001≦b≦0.1) (15)

LiₐMn₂G_{b}O₄ (0.90≦a≦1.8, 0.001≦b≦0.1) (16)

LiₐMnG_{b}PO₄ (0.90≦a≦1.8, 0.001≦b≦0.1) (17)

QO₂ (18)

QS₂ (19)

LiQS₂ (20)

V₂O₅ (21)

LiV₂O₅ (22)

LiZO₂ (23)

LiNiVO₄ (24)

Li_{(3-f)}J₂(PO₄)₃ (0≦f≦2) (25)

Li_{(3-f)}Fe₂(PO₄)₃ (0≦f≦2) (26)

LiFePO₄ (27)

In Formulas 1 through 27, A may be selected from Ni, Co, Mn, and combinations thereof. X may be selected from Al, Ni, Co, Mn, Cr, Fe, Mg, Sr, V, rare earth elements, and combinations thereof. D may be selected from O, F, S, P, and combinations thereof. E may be selected from Co, Mn, and combinations thereof. T is selected from F, S, P, and combinations thereof. G is selected from Al, Cr, Mn, Fe, Mg, La, Ce, Sr, V, and combinations thereof. Q is selected from Ti, Mo, Mn, and combinations thereof. Z is selected from Cr, V, Fe, Sc, Y, and combinations thereof. J is selected from V, Cr, Mn, Co, Ni, Cu, and combinations thereof.

The compound may have a coating layer on the surface, or may be mixed with another compound having a coating layer. The coating layer may include at least one coating element compound selected from oxides of a coating element, hydroxides of a coating element, oxyhydroxides of a coating element, oxycarbonates of a coating element, and hydroxycarbonates of a coating element. The compound for a coating layer may be amorphous or crystalline. The coating element for the coating layer may include Mg, Al, Co, K, Na, Ca, Si, Ti, V, Sn, Ge, Ga, B, As, Zr, or a mixture thereof. The coating layer may be formed by any method that does not adversely influence the properties of the positive active material by including the element(s) in the compound. For example, the method may include any coating method such as spray coating, dipping, and the like.

The positive active material layer also includes a binder and a conductive material. The binder improves the binding properties of the positive active material particles to one another, and also the binding properties of the positive active material to the current collector. Nonlimiting examples of the binder include polyvinyl alcohol, carboxymethyl cellulose, hydroxypropyl cellulose, diacetyl cellulose, polyvinylchloride, carboxylated polyvinyl chloride, polyvinylfluoride, ethylene oxide-containing polymers, polyvinylpyrrolidone, polyurethane, polytetrafluoroethylene, polyvinylidene fluoride, polyethylene, polypropylene, styrene-butadiene rubber, acrylated styrene-butadiene rubbers, epoxy resin, nylon, and the like, and combinations thereof.

The conductive material is included to improve electrode conductivity. Any electrically conductive material may be used as a conductive material so long as it does not cause a chemical change. Nonlimiting examples of the conductive material include carbon black, acetylene black, ketjen black, carbon fiber, metal powders or metal fibers including copper, nickel, aluminum, silver, and polyphenylene derivatives, and combinations thereof.

The current collector may be Al, but is not limited thereto.

The negative and positive electrodes may be fabricated by mixing the active material, a conductive material, and a binder into an active material composition and coating the composition on a current collector. The solvent may be N-methylpyrrolidone, but it is not limited thereto.

In a rechargeable lithium battery according to embodiments of the present invention, a non-aqueous electrolyte includes a non-aqueous organic solvent and a lithium salt. The non-aqueous organic solvent serves as a medium for transmitting ions taking part in the electrochemical reaction of the battery. The non-aqueous organic solvent may include a carbonate-based, ester-based, ether-based, ketone-based, alcohol-based, or aprotic solvent.

Nonlimiting examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and so on.

Nonlimiting examples of the ester-based solvent include methyl acetate, ethyl acetate, n-propyl acetate, dimethylacetate, methylpropionate, ethylpropionate, γ-butyrolactone, decanolide, valerolactone, mevalonolactone, caprolactone, and the like.

Nonlimiting examples of the ether-based solvent include dibutyl ether, tetraglyme, diglyme, dimethoxyethane, 2-methyltetrahydrofuran, tetrahydrofuran, and so on.

Nonlimiting examples of the ketone-based solvent include cyclohexanone and the like.

Nonlimiting examples of the alcohol-based solvent include ethyl alcohol, isopropyl alcohol, and so on.

Nonlimiting examples of the aprotic solvent include nitriles (such as R—CN in which R is a C2 to C20 linear, branched, or cyclic hydrocarbon, a double bond, an aromatic ring, or an ether bond), amides (such as dimethylformamide), dioxolanes (such as 1,3-dioxolane), sulfolanes, and the like.

The non-aqueous organic solvent may include a single solvent or a mixture of solvents. When the organic solvent is a mixture, the mixture ratio can be controlled in accordance with the desired battery performance.

The carbonate-based solvent may include a mixture of a cyclic carbonate and a linear carbonate. The cyclic carbonate and the chain carbonate may be mixed together in a volume ratio of 1:1 to 1:9, and when the mixture is used as an electrolyte, electrolyte performance may be enhanced.

In addition, the electrolyte of the present invention may further include mixtures of carbonate-based solvents and aromatic hydrocarbon-based solvents. The carbonate-based solvents and the aromatic hydrocarbon-based solvents may be mixed together in a volume ratio of 1:1 to 30:1.

The aromatic hydrocarbon-based organic solvent may be represented by the following Chemical Formula 28.

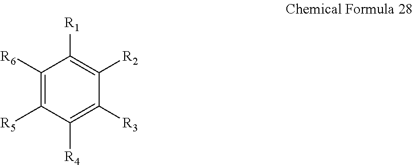

In Chemical Formula 28, each of R₁ to R₆ may be independently selected from hydrogen, halogens, C1 to C10 alkyls, C1 to C10 haloalkyls, and combinations thereof.

Nonlimiting examples of the aromatic hydrocarbon-based organic solvent include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and combinations thereof.

The non-aqueous electrolyte may further include vinylene carbonate or an ethylene carbonate-based compound of the following Chemical Formula 29.

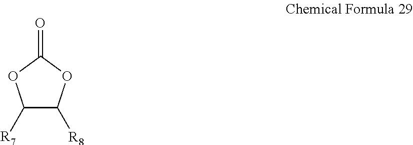

In Chemical Formula 29, each of R₇ and R₈ is independently selected from hydrogen, halogens, cyano (CN), nitro (NO₂), and C1 to C5 fluoroalkyls, provided that at least one of R₇ and R₈ is a halogen, a nitro (NO₂), or a C1 to C5 fluoroalkyls, and R₇ and R₈ are not simultaneously hydrogen.

Nonlimiting examples of the ethylene carbonate-based compound include fluoroethylene carbonate, difluoroethylene carbonate, chloroethylene carbonate, dichloroethylene carbonate, bromoethylene carbonate, dibromoethylene carbonate, nitroethylene carbonate, cyanoethylene carbonate, and the like. The amount of this additive for improving cycle life may be adjusted within an appropriate range.

The lithium salt supplies lithium ions in the battery, enables the basic operation of the rechargeable lithium battery, and improves lithium ion transport between the positive and negative electrodes. Non-limiting examples of the lithium salt include supporting salts selected from LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂ (where x and y are natural numbers), LiCl, LiI, LiB(C₂O₄)₂ (lithium bisoxalato borate; LiBOB), and combinations thereof. The lithium salt may be used at a concentration of about 0.1 to about 2.0M. When the lithium salt is included in this concentration range, electrolyte performance and lithium ion mobility may be enhanced due to optimal electrolyte conductivity and viscosity.

The rechargeable lithium battery may further include a separator between the negative electrode and the positive electrode, as needed. Nonlimiting examples of suitable separator materials include polyethylene, polypropylene, polyvinylidene fluoride, and multi-layers thereof, such as a polyethylene/polypropylene double-layered separator, a polyethylene/polypropylene/polyethylene triple-layered separator, and a polypropylene/polyethylene/polypropylene triple-layered separator.

The following examples are presented for illustrative purposes only, and do not limit the scope of the present invention.

### Fabrication of Negative Electrode

### Example 1

### Fabrication of Negative Electrode

1.0 g of carbon nanotube powder (Hanwha Nanotech Co.) was added to 1000 ml of isopropyl alcohol and then homogenized with a homogenizer for one hour. The resulting mixture was additionally dispersed using ultrasonic waves for one hour.

In addition, a 0.4 dm²-size Cu foil was treated in a 5 volume % H₂SO₄ aqueous solution to remove its surface oxide layer, and then purified by cleaning with an alkali aqueous solution to prepare a Cu current collector. An electrolytic bath was prepared by mixing 150 ml/L of Sn(CH₃SO₃)₂, 157 ml/L of Cu(CH₃SO₃H)₂, and 25 ml/L of CH₃SO₃H (Incheon Chemical Co.).

Then, a Sn electrode was used as a plating electrode, and a Cu foil was used as a plated electrode, and they were electroplated to dispose a 3 μm-thick plating layer including 90 wt % of Sn and 10 wt % of Cu on the Cu current collector, while the electrolyte solution was agitated at 50 rpm at room temperature (25° C.) at a current density of 15 Adm⁻² for 20 seconds. Next, the prepared carbon nanotube dispersion solution was deposited three times with no droplet agglomeration using a spray gun. Then, the resulting product was heat-treated at 200° C. for 4 hours, to prevent delamination of the deposited carbon nanotube layer from the plating layer. After the heat treatment, a Sn—Cu plating layer was deposited under current density of 11.5 Adm⁻¹ for 20 seconds in the same aqueous electrolyte solution. Lastly, the above product was heat-treated at 200° C. for 12 hours, thereby preparing an active material.

### Example 2

### Fabrication of Negative Electrode

A 0.4 dm²-size Cu foil was treated in a 5 volume % H₂SO₄ aqueous solution to remove a surface oxide layer and then purified by cleaning with an alkali aqueous solution, thereby preparing a Cu current collector. Next, a plating layer was disposed on the Cu current collector in the same aqueous electrolyte solution as Example 1 at a current density of 5 dm⁻² for 10 seconds.

Then, the prepared carbon nanotube dispersion solution was deposited three times with no droplet agglomeration with a spray gun. Next, the plating was performed without heat treatment at a current density of 5 dm⁻² for 10 seconds according to the same method as Example 1.

The carbon nanotube dispersion solution was deposited again on the plating layer under the same conditions as above. The resulting product was heat-treated according to the same method as Example 1. Accordingly, the active material had a multi-layered structure including a Sn (90 wt %) and Cu (10 wt %) plating layer and a carbon nanotube layer.

### Comparative Example 1

### Fabrication of Negative Electrode

A negative electrode was fabricated according to the same method as Example 1 except that the carbon nanotube dispersion solution was not used.

### Comparative Example 2

### Fabrication of Negative Electrode

A negative electrode was fabricated according to the same method as Example 2 except that the carbon nanotube dispersion solution was not used.

### Cell Fabrication

### Example 3

### Fabrication of a Cell

A 2016-type coin cell was fabricated using the negative electrode according to Example 1 and lithium metal as the positive electrode.

The electrodes were spiral-wound with a 20 μm-thick polyethylene separator and compressed together, and an electrolyte solution was injected thereto, thereby fabricating a coin cell. Herein, the electrolyte solution was prepared by dissolving LiPF₆ to a concentration of 1.15M in a mixed solvent of ethylene carbonate (EC), ethylmethyl carbonate (EMC), and diethyl carbonate (DEC) in a EC:EMC:DEC volume ratio of 3:3:4.

### Example 4

### Fabrication of a Cell

A cell was fabricated according to the same method as Example 3 except that the negative electrode according to Example 2 was instead of the negative electrode according to Example 1.

### Comparative Example 3

### Fabrication of a Cell

A cell was fabricated according to the same method as Example 3 except that the negative electrode according to Comparative Example 1 was instead of the negative electrode according to Example 1.

### Comparative Example 4

### Fabrication of a Cell

A cell was fabricated according to the same method as Example 3 except that the negative electrode according to Comparative Example 2 was instead of the negative electrode according to Example 1.

### Experimental Example

### Cross-Sectional Analysis Photograph of the Prepared Negative Electrodes

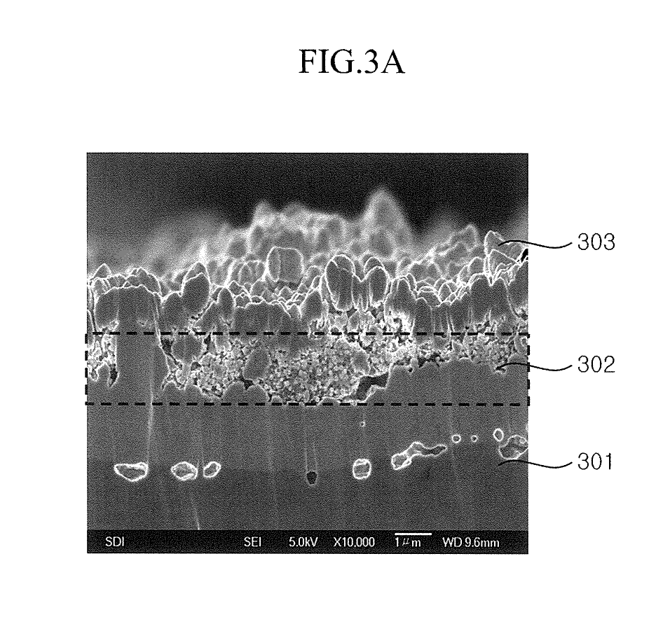

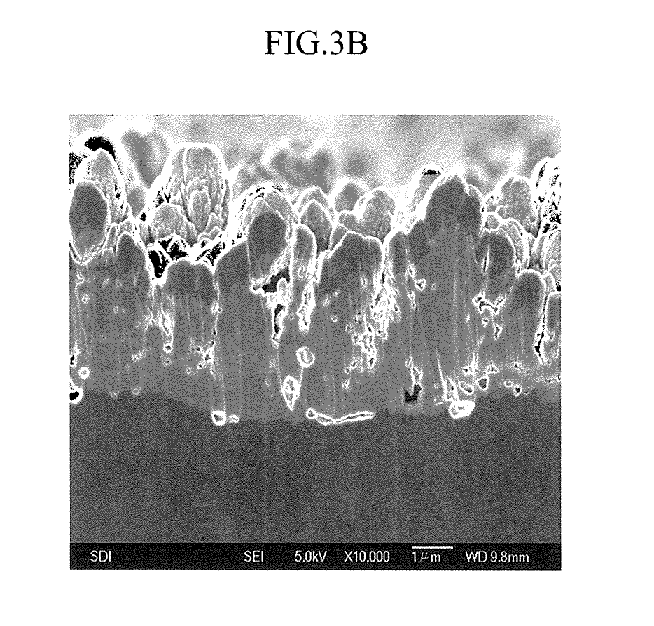

FIG. 3A is a cross-sectional SEM photograph of the negative electrode according to Example 1. As shown in FIG. 3A, the negative electrode includes a layered active material in which a carbon nanotube layer 302 is layered on a Sn metal plating layer 301, and a Sn metal plating layer 303 is layered on the carbon nanotube layer 302.

FIG. 3B is a cross-sectional SEM photograph of the negative electrode according to Comparative Example 1. The negative electrode did not include a carbon nanotube layer, unlike Example 1.

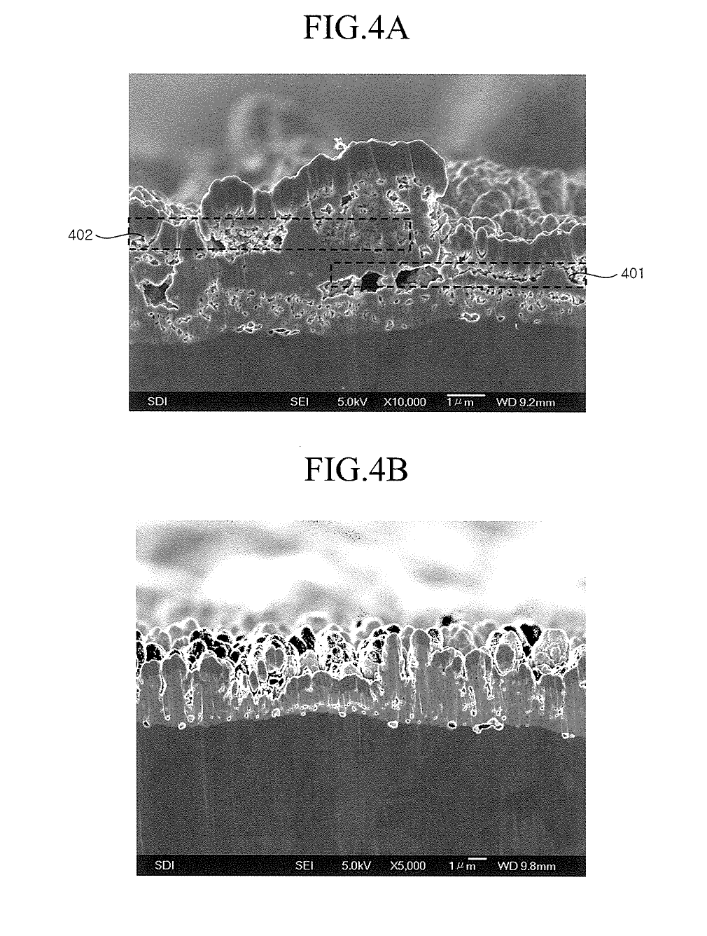

FIG. 4A is a cross-sectional SEM photograph of the negative electrode according to Example 2. The negative electrode included carbon nanotube layers 401 and 402.

FIG. 4B is a cross-sectional SEM photograph of the negative electrode according to Comparative Example 2.

### Experiment Method

The cells according to Examples 3 and 4 and Comparative Examples 3 and 4 were measured for capacity change depending on cycle number. Their capacities were measured under a constant current (CC)/constant voltage (CV) condition after one cycle, a cut-off charge of 0.01 C/0.01V at a charge and discharge speed of 1 C, and then a cut-off discharge of 1.5V with constant current (CC) of 0.1 C. Then, their life spans were measured at 0.5 C under the same cut-off condition after the charge and discharge at 0.2 C under the same cut-off condition.

### Experimental Result

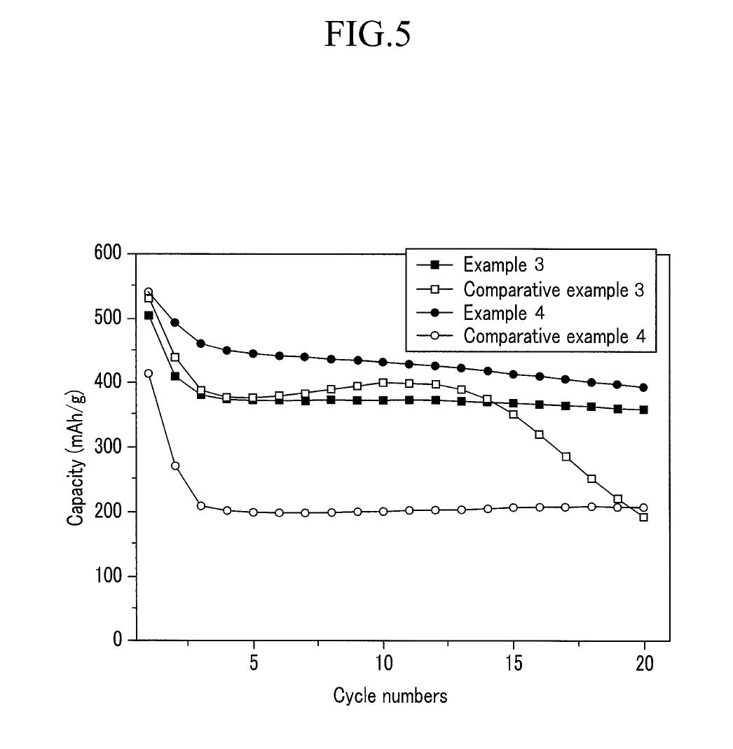

The results are provided in the following Table 1 and FIG. 5.

TABLE 1

| | | Comparative | | Comparative |
|---|---|---|---|---|
| | Example 3 | Example 3 | Example 4 | Example 4 |
| Initial capacity | 503.65 | 530.81 | 539.28 | 413.32 |
| (mAh/g) | | | | |
| 20^{th} capacity | 358.76 | 191.68 | 393.13 | 206.86 |
| (mAh/g) | | | | |
| Capacity | 71 | 36 | 73 | 50 |
| retention (%) | | | | |

As shown in the data, the cells according to Examples 3 and 4 had good capacity retention as the cycle number increased.

While this invention has been described in connection with certain exemplary embodiments, those of ordinary skill in the art will understand that the present invention is not limited to the disclosed embodiments and that various modifications and changes can be made to the described embodiments without departing from the spirit and scope of the appended claims.

1. A negative electrode for a rechargeable lithium battery, comprising at least one layered unit comprising:
at least one metal plating layer comprising Sn; and
at least one carbon layer laminated on the at least one metal plating layer.

2. The negative electrode of claim 1, wherein the metal plating layer is about 1 to about 5 μm thick.

3. The negative electrode of claim 1, wherein the metal plating layer has a surface roughness ranging from about 1000 to about 10,000 Å.

4. The negative electrode of claim 1, wherein the carbon layer comprises a material selected from the group consisting of carbon nanotubes, amorphous carbon, carbon nanowires, carbon nanorods, and combinations thereof.

5. The negative electrode of claim 1, further comprising second metal plating layer laminated on the layered unit.

6. The negative electrode of claim 1, wherein the at least one layered unit comprises 1 to 3 layered units.

7. A method of manufacturing a negative electrode for a rechargeable lithium battery, comprising:
a) preparing a current collector; and
b) depositing at least one layered unit on the collector, wherein depositing the layered unit comprises:
depositing a metal plating layer comprising Sn on the current collector; and
depositing a carbon layer on the metal plating layer.

8. The method of claim 7, further comprising repeating the depositing the at least one layered unit at least once.

9. The method of claim 7, wherein the metal plating layer is about 1 to about 5 μm thick.

10. The method of claim 7, wherein the metal plating layer has a surface roughness ranging from about 1000 to about 10,000 Å.

11. The method of claim 7, wherein the carbon layer comprises a material selected from the group consisting of carbon nanotubes, amorphous carbon, carbon nanowires, carbon nanorods, and combinations thereof.

12. The method of claim 7, further comprising depositing a second metal plating layer comprising Sn on the at least one layered unit.

13. The method of claim 7, wherein the depositing the at least one layered unit comprises depositing 1 to 3 layered units.

14. The method of claim 7, further comprising heat-treating the negative electrode after depositing the carbon layer, wherein the heat-treatment is performed at a temperature ranging from about 200 to about 250° C. for about 2 to about 6 hours.

15. The method of claim 7, wherein the depositing the carbon layer comprises preparing a suspension by dispersing a carbon material in a solvent and spraying the suspension on the metal plating layer.

16. The method of claim 15, wherein the solvent comprises a solvent selected from the group consisting of ethanol, isopropyl alcohol, methanol, and combinations thereof.

17. A rechargeable lithium battery comprising:
a positive electrode comprising a positive active material;
a negative electrode comprising at least one layered unit comprising:
a Sn-based metal plating layer; and
a carbon layer laminated on the metal plating layer;
a separator between the positive and negative electrodes; and
an electrolyte.

18. The rechargeable lithium battery of claim 17, further comprising a second Sn-based metal plating layer on the at least one layered unit.

19. The rechargeable lithium battery of claim 17, wherein the metal plating layer has a surface roughness ranging from about 1000 to about 10,000 Å.

20. The rechargeable lithium battery of claim 17, wherein the at least one layered unit comprises 1 to 3 layered units.
